(19) United States
(12) Patent Application Publication
(10) Pub. No.: US 2008/0215908 A1
(43) Pub. Date: Sep. 4, 2008

(54) Sleep Watchdog Circuit For Asynchronous Digital Circuits

(75) Inventors: Clemens Gerhardus De Haas, Ewijk (NL); Franciscus Johannes Kloesters, Schaijk (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/914,228

(22) PCT Filed: May 3, 2006
(86) PCT No.: PCT/IB06/51389

§ 371 Date: Nov. 12, 2007

(30) Foreign Application Priority Data
May 10, 2005 (EP) 05103885.9

(51) Int. Cl. G06F 1/04

(52) U.S. Cl. 713/502

(57) ABSTRACT

The sleep watchdog circuit for asynchronous circuits of the present invention contains clock means, counting means with multiple trigger input function and a digital supply. When the circuit is in the normal operation state, a periodic reset or activity signal is present that will reset the watchdog counter. As a result the clock means will keep on running, and the digital supply is operating in “normal” mode. When the circuit is put into the “sleep/standby” state, the “activity” signal becomes inactive, and if no wakeup events occur before the counter is finished the clock means will be put to a halt and the digital supply changes into a low power mode.

The present invention relates to a sleep watchdog circuit for asynchronous digital circuits and to a method for switching asynchronous circuits between a normal operation mode and a sleep mode using a sleep watchdog circuit.

Integrated circuits (IC) are used in for a variety of devices, including microprocessor, audio and video equipment, and automobiles. Due to the power limitations of the power system in automotive products the demands for low current consumption automotive ICs are increasing.

It is known that circuit design styles can be classified into two major categories, namely synchronous and asynchronous. The vast majority of digital and mixed, i.e. digital and analog, signal circuit design is concerned with synchronous circuits. Synchronous circuits may simply be defined as circuits which are sequenced by one or more globally distributed periodic timing signals called clocks.

Asynchronous circuits remove the need for a global synchronizing clock. In general there is no clock to govern the timing of state changes. Subsystems exchange information at mutually negotiated times with no external timing regulation. Instead, the process of computation may be controlled though local clocks and local handshaking and handoff between adjacent units. Such local control permits resources to be used only when they are necessary. Standard synchronous circuits have to clock portions of a circuit unused in the current computation. Although asynchronous circuits often require more transitions during computation than synchronous circuits, they generally have transitions only in areas involved in the current computation. As a result, asynchronous circuits consume less power, which is of particular importance in automotive applications.

U.S. Pat. No. 6,014,749 by Gloor et al. discloses a data processing circuit with a self-timed instruction execution unit, which operates asynchronously. The used power supply voltage is being evaluated to be just high enough to provide a processing power fast enough to execute the instructions in time, depending on the processor load.

However, although asynchronous circuit design is more power-efficient than synchronous, there is still the need, particularly in automotive applications, to reduce the standby currents in order to prevent a dead battery after a long parking period.

A lot of mixed signal products offer a kind of standby/sleep mode in which the current consumption is reduced and a wake-up functionality is provided in order to change into normal operating conditions. Only in the latter mode the current consumption is allowed to be higher.

In standby/sleep mode of mixed signal synchronous circuits most analog blocks are switched off, only a digital supply, an oscillator serving as a clock and a digital part are consuming current due to the active clock.

Some techniques are known to reduce the sleep current. In case of synchronous digital designs one of the method is clock-gating, thus only the digital that is responsible for the wake-up functionality is running and consuming current.

In case of asynchronous design the clock is not needed for operation of a digital device. When there are no events the digital consumes no current. However, most wake-up events require a filter to prevent a faulty wakeup condition caused by glitches. Those timers are implemented as a digital version instead of an analog timer because of the larger chip area analog timers consume. A digital timer/filter needs a time reference, and in many case this is based on a ripple counter with a clock as input. This part of the digital is always functional and therefore consuming current.

An example to reduce the quiescent current in an asynchronous design is also to switch off the corresponding oscillator (clock). This can be done by an on/off control of the oscillator as part of the main state machine. Upon entering sleep/standby the main digital stops the clock. In case of a wakeup call the oscillator receives a signal to start running again to provide a time reference. If the wakeup condition was valid, the state will change from sleep to normal and the clock keeps running. If it was a glitch, the main digital needs stop the oscillator again.

A disadvantage of this solution is that the main digital needs to explicitly stop the clock for all possible cases. In a consequence, for any new design one needs to check whether the oscillator is running when needed increasing the complexity of the design.

It is an object of the present invention to provide a flexible device and method to save power in a sleep/standby mode using asynchronous logic.

According to an aspect of the present invention for achieving the above objects a sleep watchdog circuit for an asynchronous circuit is provided, comprising clock means providing timing and having an on/off input, counting means for counting time intervals and having a reset, and digital supply means providing supply to said asynchronous circuit, said clock means being coupled to said counting means and to said asynchronous circuit, said counting means being coupled to said on/off input of said clock means and to said digital supply, and said asynchronous circuit being coupled to said reset of said counting means for transmitting reset signals.

Preferably said clock means is realized by an oscillator and said counting means is realized by a ripple counter. Said reset signals comprise activity and/or wake-up signals.

It is an advantage of the present invention that the sleep watchdog according to the invention allows to switch on and off a digital supply and a clock autonomously. The reset of the counter allows to reset the counter while running and thus to keep the system including the clock and the digital supply alive upon receiving reset signals corresponding to an activity from the coupled asynchronous circuit. If the counter is in standby/sleep mode the reset signals allow waking-up and resetting the counter upon receiving reset signals corresponding to a wake-up signal from the asynchronous circuit. The counter wakes up the coupled digital supply and clock. The clock provides timing for the coupled counter and asynchronous circuit. In this way the present invention allows to save power in a sleep/standby mode of an already low power design method using asynchronous logic.

Preferably said asynchronous circuit is a digital or a mixed signal asynchronous circuit. The time constant defined by said counting means is preferably greater to a maximum repetition rate of said reset signal.

It is advantageous to provide every function in sleep/standby that requires a time reference with the ability to transmit reset signals.

In a preferred embodiment said asynchronous circuit is realized by a divider being coupled on input to said clock means, and on output to digital components of an asynchronous main digital, wherein said divider divides said timing signal to said at least one digital component of said asynchronous main digital, and at least one analog component being coupled to said asynchronous main digital having input ports for receiving wakeup signals from at least one wakeup source. Said asynchronous main digital preferably provides at least one activity signal. Said reset signals, i.e. activity signals and wake-up signals, are preferably transmitted to the reset of said counting means via an OR gate.

In another preferred embodiment of the invention said asynchronous main digital is a local interconnect network (LIN) and said analog blocks are realized by I/O ports. In this embodiment said activity signal is derived from the internal RxD signal of said local interconnect network and the output of a longest timer of a component of said circuit.

Accordingly, the invention provides a method for switching asynchronous circuits between a normal operation mode and a sleep mode, wherein said normal operation mode relates to running counting means, clock means, and digital supply means, switching from a normal into a sleep mode comprises the steps of: running of said counting means; stopping of transmission of activity or wake-up signals from all components of an asynchronous circuit coupled to a reset of said counting means; finishing counting of said counting means having not received a reset; and switching off said clock means and said digital supply means by said counting means; and wherein switching from a sleep mode into a normal mode comprises the steps of transmitting activity or wake-up signals from at least one component in said circuit to said reset of said counting means; resetting the counting means; switching on said clock means; and switching on said digital supply means.

Accordingly, the method allows to switch the digital supply means and clock means into a low power mode autonomously. As a result, the power consumption can be reduced to a minimum decreasing the complexity of the design of the circuit.

Preferably said output of said counting means is set to a low voltage level when counting is finished and to a high voltage level otherwise.

In another preferred embodiment said output of said counting means is set to 0 when counting is finished and to 1 otherwise.

Preferably, switching from a sleep mode into a normal mode further comprises the step of clocking said counting means and said asynchronous circuit by said clock means.

The foregoing and other objects, features, and advantages of the invention will be apparent from the following more particular description of preferred embodiments of the invention, as illustrated in the accompanying drawings.

The present invention will now be described by way of example with reference to the accompanying drawings, in which:

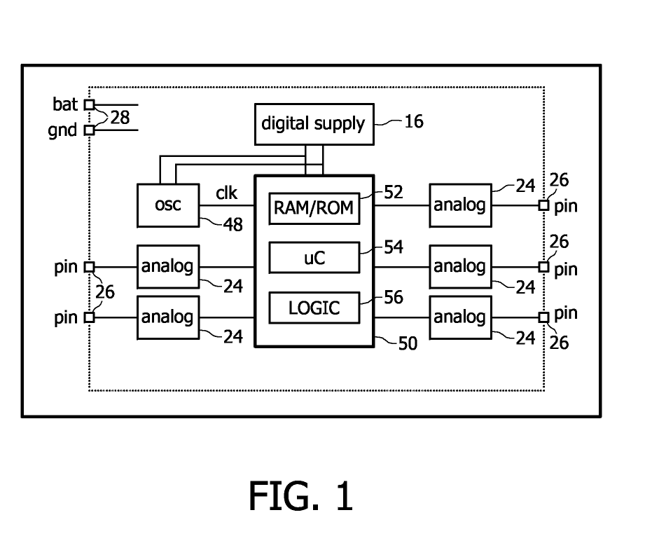

FIG. 1 shows a block diagram of a mixed signal integrated circuit of the state of the art;

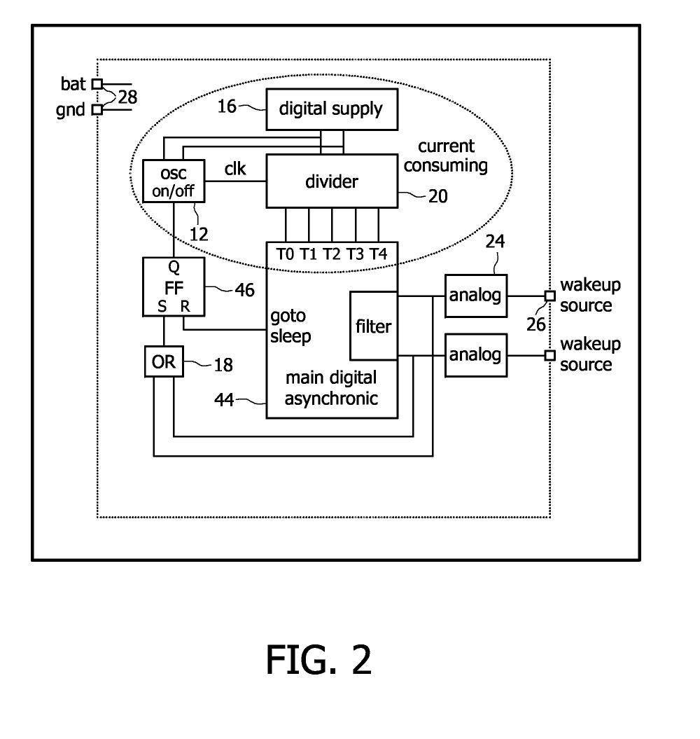

FIG. 2 shows a block diagram of an example to reduce quiescent current in an asynchronous design known in the art;

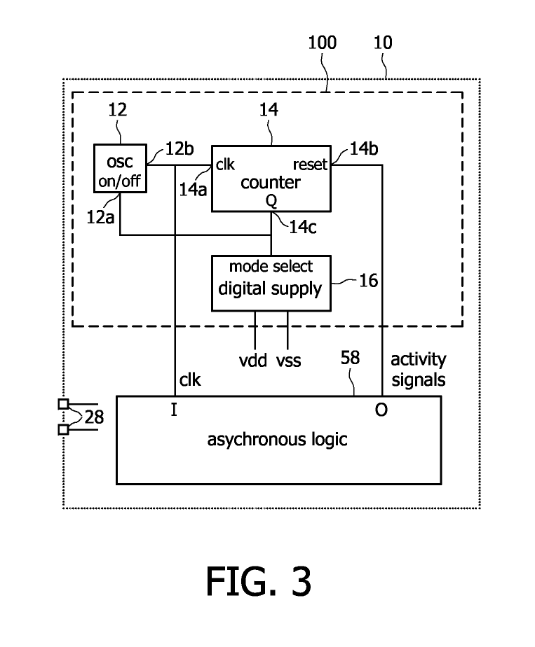

FIG. 3 shows a block diagram of the sleep watchdog device in a preferred embodiment of the invention;

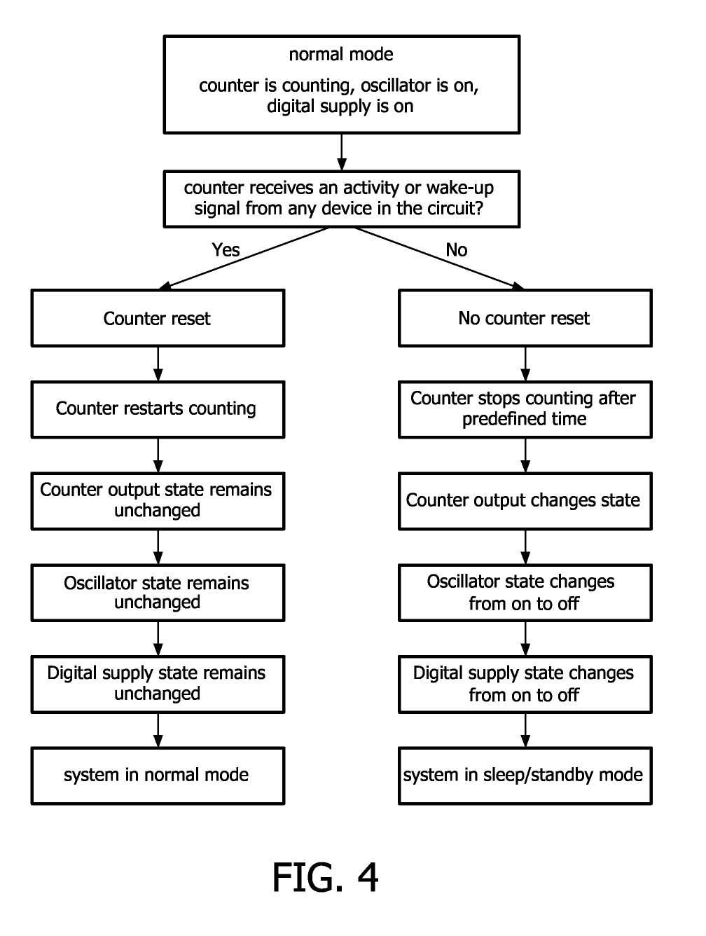

FIG. 4 shows a flow chart of the change of the state of the autonomous watchdog from normal to sleep/standby mode according to the invention;

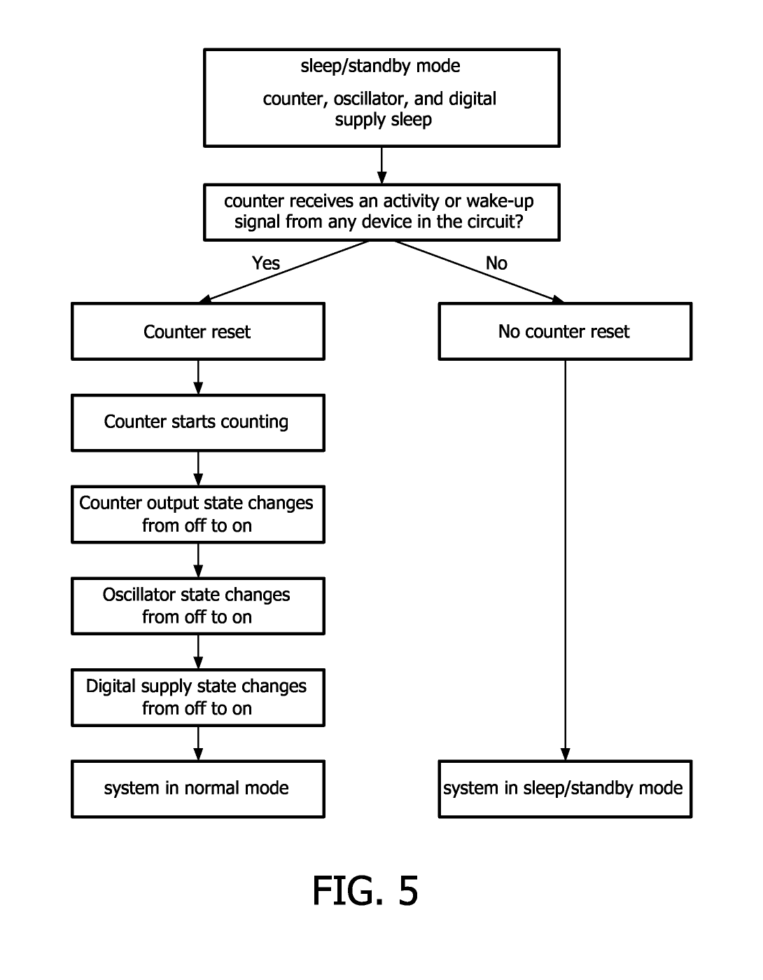

FIG. 5 shows a flow chart of the change of the state of the autonomous watchdog from sleep/standby mode to normal mode according to the invention;

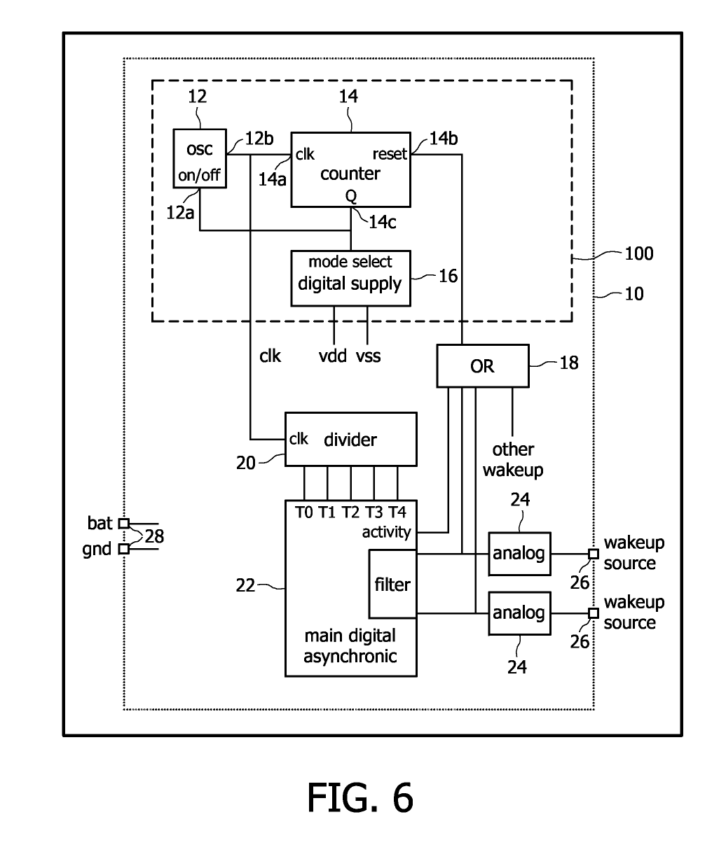

FIG. 6 shows a block diagram of the sleep watchdog device in another embodiment of the invention; and

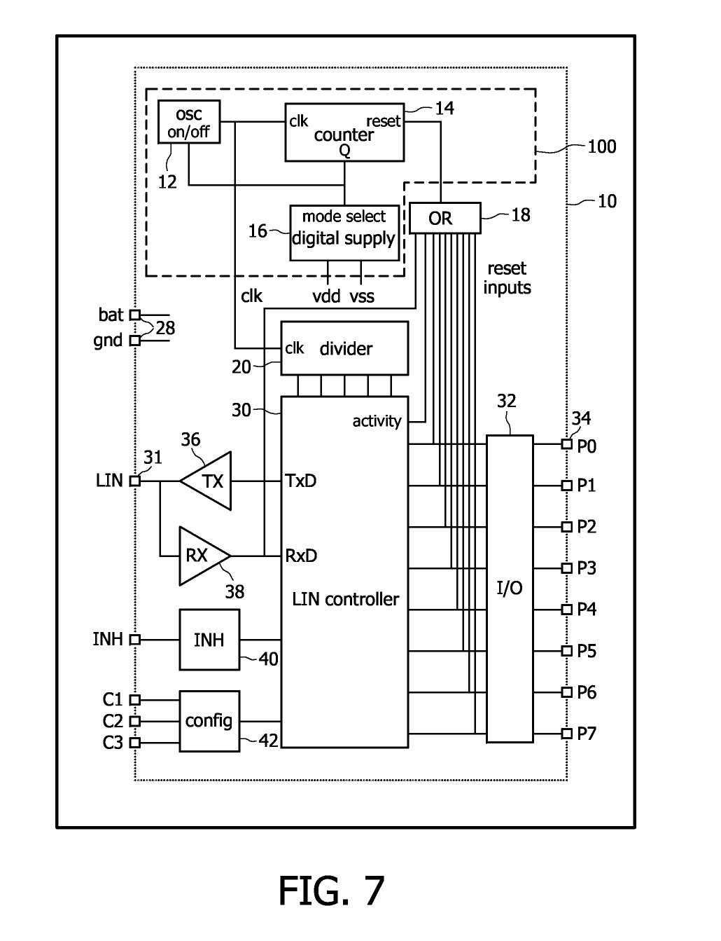

FIG. 7 shows a block diagram of the sleep watchdog device coupled to a local interconnect network embodiment of the invention.

FIG. 1 shows a mixed signal integrated circuit (IC) of the state of the art. The integrated circuit is coupled to a battery 28. A mixed signal IC in general is provided with analog and digital components. The IC of FIG. 1 comprises a digital supply 16, an oscillator 48, analog components 24 coupled to an application via pins 26, and a digital unit 50. The digital unit 50 comprises a RAM/ROM 52, a microprocessor (IC) 54, and a logic 56. The oscillator 48 serves as a clock and clocks the digital part of the circuit. However, the IC could also comprise digital components only.

In standby/sleep most of the analog blocks 24 are switched off, only the digital supply 16, oscillator 48 and the digital unit 50 is consuming current, since the clocking by the oscillator 48 is active. An object of the present invention is to reduce this current.

FIG. 2 shows an example to reduce the quiescent current in an asynchronous design known in the art. The circuit comprises a battery 28, analog components 24, coupled to possible wakeup sources via pins 26, a digital supply 16, a divider 20, an oscillator 12 having an on/off function, an asynchronous main digital 44, a flip-flop 46 and an OR gate 18. The digital supply 16 is coupled with the divider 20, which is clocked by said oscillator 12 and divides the clock. The divider 20 is coupled with inputs, e.g. T0-T4, of the asynchronous main digital 44. The main digital 44 is coupled with the analog components 24 via a filter. The analog components 24 are further coupled via said OR gate 18 with a flip-flop (FF) 46 set input S. The asynchronous main digital 44 provides a go to sleep signal to the reset R of the flip-flop 46. The output Q of the flip-flop 46 is coupled with the oscillator 12 on/off input.

In such a circuit, switching off the oscillator 12 can be done under control of the main digital 44. When the sleep/standby is entered the flip-flop 46 is given a reset signal, Q will become ‘0’ and the oscillator 12 will stop running. In case of a wakeup condition the flip-flop 46 is set via the OR gate 18 and the oscillator 12 starts running to provide a time reference for the wakeup filtering. If the wakeup condition was valid, the state will change from sleep to normal. If it was a glitch, the main digital needs stop the oscillator 12 again.

A disadvantage of this solution is that on/off control of the oscillator 12 is part of the main state machine 44, and with each new design one would have to check whether the oscillator 12 is running when needed. This results also in software overhead and more room space and a higher complexity of circuit design.

The present invention uses an autonomous sleep watchdog to save quiescent current by shutting down the remaining active digital circuits and puts the digital supply block in a low power mode. The corresponding block diagram is shown in FIG. 3.

The circuit 10 of FIG. 3 powered by a power unit 28 shows the autonomous watchdog 100 according to the invention having multiple trigger input function comprising clock means 12, counting means 14, and a digital supply 16, wherein the watchdog is coupled to an asynchronous circuit 58. Counting means 14 is provided with an input for clocking 14a, and input for resetting 14b, and an output 14c. The counting means input for clocking 14a is coupled with the clock means output 12b. The counting means reset 14b receives reset signals, e.g. comprising activity and/or wakeup signals, from the asynchronous circuit 58. Counting means output 14c is coupled with the on/off switch of the clock means 12a, and with the digital supply 16. The digital supply 16 has a positive supply voltage vdd and a negative supply voltage vss for supplying the digital components of the asynchronous circuit 58.

The clock means 12 is preferably an oscillator. The counting means 14 is preferably realized by a ripple counter. The power unit 28 can be, e.g., a battery, as in automotive applications or any other power supply. The time interval counter 14 sets the time interval to a multiple of the period of the corresponding clock oscillator 12. The output of the time interval counter 14 changes its output signal when the count value reaches a predetermined value. This value could e.g. be zero.

Note that the oscillator is not used as a global clock for a related CPU and logic as used in synchronous logic. Asynchronous logic is used because of its advantageous low power behaviour. The oscillator is used for provide timing references.

When the circuit 10 is in the “normal” state, there is a periodic reset or “activity” signal that will reset the watchdog counter. This means that the oscillator 12 will keep on running, and the digital supply 16 is operating in “normal” mode.

FIG. 4 shows a flow chart of the change of the state of the autonomous watchdog from normal to sleep/standby mode according to the invention.

In normal mode counting means, here e.g. a ripple counter, clock means, here e.g. an oscillator, and digital supply are “on”. The counter is counting. If the counter receives a reset signal, e.g. an activity or a wake-up signal, then the counter is reset and restarts counting, while its output state remains unchanged. The oscillator and the digital supply coupled to the counter output also remain unchanged. Therefore, the system as a whole stays in normal mode, the coupled asynchronous circuit stays alive and active.

Otherwise, if the counter stops receiving activity or wake-up signals, no counter reset occurs, the counter finishes counting after a predefined time and then changes its output state from on to off. In result, also the oscillator and the digital supply coupled to the output state of the counter also change their state from on to off and the system changes into sleep/standby mode.

FIG. 5 shows a flow chart of the change of the state of the autonomous watchdog 100 from sleep/standby mode to normal mode according to the invention. At the beginning the circuit is in standby/sleep mode, i.e. the counter 14, oscillator 12, and digital supply 16 are all sleeping, and in a low power mode. When the counter 14 receives a reset signal in form of, e.g., an activity or wake-up signal, the counter 14 is reset and restarts counting. The counter output 14c changes from off to on being followed by the oscillator 12 and digital supply 16, which also change their mode from off to on. The system is now in normal mode.

If at the beginning the counter 14 does not receive a reset, nothing changes and the systems stays in sleep/standby mode.

The so-called “activity” signal can be a signal that is used for a certain function, or can be one of the outputs of a divider used in the asynchronous circuit 58. When the IC is put into the “sleep/standby” state, the “activity” signal becomes inactive, and if no wakeup events occur before the counter 14 is finished the oscillator 12 will be stopped and the digital supply 16 changes into a low power mode.

The low power mode of the digital supply 16 means less current consumption in exchange for a less stable output voltage. This is possible in case of supplying an asynchronous circuitry with digital components 58 because that kind of circuitry only gets slower with a lower supply voltage while still functioning correctly. Note that in a sleep/standby condition there is no need for a fast digital. The invention discloses a safe way to enter the corresponding low power mode as an easy implementation.

In case of a glitch the oscillator 12 will start running. The digital evaluates the wakeup source and since no source is present will ignore the wakeup and stay in sleep/standby mode. The reset of activity signal will stay inactive, and after the predefined timeout the watchdog 100 will autonomously go to low power.

The difference with the existing solution (see FIG. 2) is that the decision to go to sleep is autonomous. No added function in the digital circuit is needed for the above process. In contrast, in the solution showed in FIG. 2 the digital additionally needed to stop the oscillator 12 after determining that the wakeup was caused by a glitch.

In a preferred embodiment there are two conditions that should be fulfilled. The first is that the time constant defined by the counter 58 in the watchdog 100 should be greater compared to the maximum repetition time of the “activity” signal, and thus greater compared to the other timers used in the IC. This is the only condition the digital part needs to fulfill and this condition is easy to oversee. The second condition is that any function in sleep/standby that would require a time reference for wakeup can reset the watchdog 100 via the reset input 14b.

FIG. 6 shows the autonomous watchdog 100 of the present invention of FIG. 3 with a detailed asynchronous circuit 58. The asynchronous circuit comprises a divider 20 clocked by said clock means 12 and coupled to input ports of an asynchronous main digital 22, e.g. ports T0-T4, analog blocks 24, coupled to possible wake-up sources via pins 26, and an OR gate 18 with reset signals, e.g. activity or wake-up signals, on input, and coupled to the counter 14 reset on output.

The invention can be used for various mixed signal or digital products. FIG. 7 shows an application to a local interconnect network (LIN) used in automotive products for communication. It should be noted that the invention is applied to circuits used in the automobile industry just by way of example. It can be applied to any mixed signal or digital circuit. Moreover, it can also be applied to different communication networks, e.g. the controller area network (CAN).

The digital part in FIG. 7 is a LIN controller 30, the analog parts are eight IO ports 32, a LIN transmitter/receiver 36/38, three dedicated inputs for address configuration 42 and a inhibit INH switch 40.

The LIN slave has multiple operating modes resulting in three different states in which a sleep/standby behavior is required. In sleep it is possible to wakeup the device via the LIN bus 31, and via one of the eight as input configured IO pins 34. The activity signal is derived from the internal RxD signal and the output of the longest timer. The output of the analog IO blocks 32 and a activity signal coming from the LIN controller 30 form the reset for the sleep watchdog 100. The watchdog time is chosen greater compared to the longest functional timer.

The non-autonomous solution (see FIG. 2) would have to provide a go to sleep signal, and that signal would result from three different states making the design more complex and increasing the chance of having a certain state, in which the go-to-sleep signal is not activated.

The autonomous watchdog of the present invention can be applied to all digital and mixed signal ICs that use asynchronous digital and have a state in which low current consumption is important.

While this invention has been described in conjunction with specific embodiments thereof, it is evident that many alternatives, modifications and variations will be apparent to those skilled in the art. Accordingly, the preferred embodiments of the invention as set forth herein are intended to be illustrative, not limiting. Various changes may be made without departing from the spirit of the invention as defined in the following claims.

### LIST OF REFERENCE NUMERALS

100 Sleep watchdog circuit
10 Asynchronous circuit
12 Clock means/oscillator
12a on/off
12b output
14 Counting means/counter with
14a input
14b reset input
14c output
16 Digital supply
18 OR gate
20 Divider
22 Main digital
24 Analog components
26 Pin
28 Power unit/Battery
30 LIN controller
31 LIN bus
32 Input/output
34 Pins
36 Tx
38 Rx
40 Inh
42 Config
44 Main digital
46 Flip-flop
48 Oscillator
50 Digital circuit
52 Memory
54 Microprocessor
56 Logic
58 Asynchronous circuit

1. Sleep watchdog circuit for an asynchronous circuit comprising:
clock means providing timing and having an on/off input,
counting means for counting time intervals and having a reset, and
digital supply means providing supply to said asynchronous circuit,
said clock means being coupled to said counting means and to said asynchronous circuit, said counting means being coupled to said on/off input of said clock means and to said digital supply, and said asynchronous circuit being coupled to said reset of said counting means for transmitting reset signals.

2. The circuit according to claim 1,
characterized in
that said clock means is realized by an oscillator.

3. The circuit according to claim 1,
characterized in
that said counting means is realized by a ripple counter.

4. The circuit according to claim 1,
characterized in
that said reset signal comprises activity and/or wake-up signals.

5. The circuit according to claim 1,
characterized in
that said asynchronous circuit is a digital or a mixed signal asynchronous circuit.

6. The circuit according to claim 1,
characterized in
that the time constant defined by said counting means is greater as a maximum repetition rate of said reset signal.

7. The circuit according to claim 1,
characterized in
that any function in sleep/standby that requires a time reference provides reset signals.

8. The circuit according to claim 1,
characterized in
that said asynchronous circuit is realized by a divider being coupled on input to said clock means, and on output to digital components of an asynchronous main digital, wherein said divider divides said timing signal to said at least one digital component of said asynchronous main digital, and at least one analog component being coupled to said asynchronous main digital having input ports for receiving wakeup signals from at least one wakeup source.

9. The circuit according to claim 1,
characterized in
that said asynchronous main digital provides at least one activity signal.

10. The circuit according to claim 1,
characterized in
that said activity signal and said wake-up signals are transmitted to the reset of said counting means via an OR gate.

11. The circuit according to claim 1,
characterized in
that said asynchronous main digital is a local interconnect network and said analog blocks are realized by I/O ports.

12. The circuit according to claim 1,
characterized in
that said activity signal is derived from the internal RxD signal of said local interconnect network and the output of a longest timer of a component of said circuit.

13. Method for switching asynchronous circuits between a normal operation mode and a sleep mode using a sleep watchdog circuit, wherein
said normal operation mode relates to running counting means, clock means, and digital supply means,
switching from a normal into a sleep mode comprises the steps of:
running of said counting means;
stopping of transmission of reset signals from all components of an asynchronous circuit, coupled to a reset of said counting means;
finishing counting of said counting means having not received a reset; and
switching off said clock means and said digital supply means by said counting means; and
wherein switching from a sleep mode into a normal mode comprises the steps of
transmitting reset signals from at least one component in said asynchronous circuit to said reset of said counting means;
resetting the counting means;
switching on said clock means; and
switching on said digital supply means.

14. The method according to claim 13,
characterized in
that said reset signal comprises activity and/or wake-up signals.

15. The method according to at claim 13,
characterized in
that an output of said counting means is set to a low voltage level when counting is finished and to a high voltage level otherwise.

16. The method according to claim 13,
characterized in
that an output of said counting means is set to 0 when counting is finished and to 1 otherwise.

17. The method according to claim 13,
characterized in
that switching from a sleep mode into a normal mode further comprises the step of clocking said counting means and said asynchronous circuit by said clock means.
